(19) United States
(12) Patent Application Publication
(10) Pub. No.: US 2021/0376588 A1
(43) Pub. Date: Dec. 2, 2021

(54) APPARATUS, SYSTEM, AND METHOD FOR WIRE STABILITY AND PROTECTION

(71) Applicant: Musco Corporation, Oskaloosa, IA (US)

(72) Inventors: KURT C. HERR, JR., CENTERVILLE, IA (US); NATHANAEL J. VAN EE, OSKALOOSA, IA (US)

(21) Appl. No.: 17/303,243

(22) Filed: May 25, 2021

Related U.S. Application Data
(60) Provisional application No. 63/029,740, filed on May 26, 2020.

(51) Int. Cl. H02G 3/32; H02G 3/34

(52) U.S. Cl. CPC H02G 3/32; F21V 23/001; H02G 3/34

(57) ABSTRACT

It is common to bundle plural conductor wires (e.g., via cable tie) when conductor wires are run collectively some distance (e.g., from the back of a computer tower to related devices (e.g., mouse, monitor)). Oftentimes bundled conductor wires are broken or damaged—potentially posing a shock hazard—when conductor wires are bundled too tightly or bent at too extreme an angle. These concerns are exacerbated in long runs of conductor wire in enclosed spaces where friction and strain relief also become concerns—for example, in large scale applications where tall, substantially hollow poles contain long runs of conductor wire which connect devices at or near the top of the pole to devices at or near the bottom of the pole. Disclosed herein are apparatus and methods of supporting runs of conductor wire in a manner that overcomes the above deficiencies, and further provides stability and protection.

### CROSS-REFERENCE TO RELATED APPLICATIONS

This application claims priority under 35 U.S.C. § 119 to provisional U.S. application Ser. No. 63/029,740, filed May 26, 2020, hereby incorporated by reference in its entirety.

### TECHNICAL FIELD OF INVENTION

The present invention generally relates to apparatuses, systems, and methods of supporting runs of wire (e.g., by providing strain relief, in situ positioning, bundling, reducing friction). More specifically, the present invention relates to providing stability and protection to long runs of conductor wire (e.g., dozens of feet) which (i) electrically conductively (e.g., via electrical current or power transmission)connect geographically remote devices and/or (ii) provide a route for or otherwise facilitate/conduct signal transfer (e.g., via control, monitoring, sensing, feedback, communication, or other information transmission).

### BACKGROUND OF THE INVENTION

It is common to bundle plural conductor wires (e.g., via cable tie) when wires are run collectively some distance; for example, from the back of a computer tower to related devices such as a mouse or monitor. As is well known, care must be given to avoid bundling conductor wires too tightly or bending said wires at too extreme an angle—wires can be broken or damaged, or wire insulation can be compromised thereby posing a shock hazard. Often conductor wires will also be protected with some means (e.g., tubing, conduit) which can be used in conjunction with said bundling so to create a cable management system which addresses, to some degree, the need for both stability and protection of wires. This is both well-known and widely practiced across the electrical arts whether residential or commercial, indoor or outdoor.

For large scale applications such as that illustrated in FIGS. 1A-C providing stability and protection is not merely a matter of adding more bundles or conduit to accommodate longer lengths of conductor wire; there is also the issue of addressing concerns with strain relief and wire isolation. Consider a lighting installation in which a target area 5 is illuminated by arrays 1 of lighting fixtures 2 which are spaced about and elevated above target area 5 by poles 6. Electrical power 9 is delivered to the site (e.g., via utility company), transported via conductor wiring 10 to a power distribution cabinet 11 where power is metered out, and further transported via conductor wiring 12 to each pole 6 where power is conditioned for the load (here, one or more LED lighting fixtures 2) at one or more electrical enclosures 13 (here, at one or more drivers/power means 3). This is well known in the art of lighting (particularly sports lighting), though U.S. Pat. No. 8,537,516, incorporated by reference herein, provides additional background information specific to outdoor lighting applications such as that in FIGS. 1A-C.

Once metered and conditioned power leaves electrical enclosure 13 as a bundle of conductor wires it travels more or less vertically via conductor wires 14 (illustrated in FIG. 1C as a single conductor wire for clarity) through many feet of substantially hollow pole 6—which could be a single pole or in sections, a single diameter or tapered, or even comprise an elongated structural member that can elevate devices or components (but is not a hollow pole as illustrated in the Figures)—where it is bent or otherwise manipulated near a removable pole cap 20 and routed through a substantially hollow crossarm 7 where it is portioned out to each fixture 2 through an electrical connection in each associated knuckle 4. As may be appreciated, for the scenario just described not only must conductor wires be bundled and guided along the substantial length of pole 6 (e.g., dozens of feet, including 24 feet to a hundred or more feet), and not only must conductor wires be positioned in situ (e.g., to power fixtures 2), but conductor wires may need to be identified and isolated at different lengths at different vertical and horizontal positions in an array 1 (e.g., to provide power to upper and lower crossarms 7). All of this is in addition to requirements for strain relief for conductors run vertically (see, e.g., National Electric Code (NEC) 300.19, 2017 version).

Further, the available space within pole 6 is limited, and as each fixture 2 requires dedicated conductor wiring 14, and as there is generally a need to add as many lighting fixtures as a pole can safely support to reduce project cost, there can be a significant amount of friction between conductor wires 14 in the limited space along the vertical span of pole 6. Also, for long lengths of conductor wire (see, e.g., the table of aforementioned NEC 300.19) a mid-point handhole 15 must be added to pole 6 for access to the interior space of the pole for the sole purpose of allowing a contractor to install a strain relief device; see FIG. 1B. Not only does the addition of handhole 15 add cost to any project, failure to correctly install the mid-point strain relief device (which often happens) places undue stress on any strain relief device at the top of the pole (e.g., accessed via pole cap 20)—which can damage wiring at the top of the pole and reduce integrity thereof beyond what would have existed with no strain relief means at all.

The art would benefit from improved means of supporting long runs of conductor wire which provide needed stability and/or protection. The art would further benefit if the aforementioned could be applied to longer lengths of conductor wire than what is possible using state-of-the-art systems. Further still, the art would benefit if all of the aforementioned could be applied while remaining below threshold loads carried by the conductor wires such that devices such as handholes 15 currently needed—see applicable NEC and Underwriters Laboratories (UL) codes—could be eliminated and, therefore, cost reduced.

Thus, there is room for improvement in the art.

### SUMMARY OF THE INVENTION

When connecting long runs of conductor wire (e.g., dozens to more than 100 feet) between geographically remote devices (e.g., lighting fixtures at the top/distal end of a pole and power means at the bottom/proximate end of said pole), a number of stability and protective means are required. Conductor wires are more stable and easily managed in situ when bundled, and conductor wires are more protected when contained in conduit, for example. That being said, oftentimes a lack of space (e.g., in the interior of a substantially hollow pole) creates friction between conductor wires—between a conductor wire and the internal surface of a pole at a gap in the conduit, or between two conductor wires when one is bent and routed in a different direction from the rest of the bundle, for example—when conventional means are used. Further, said conventional means of providing stability and protection to long runs of conductor wire can actually compromise the integrity of the conductor wire (to the point of inoperability) if done incorrectly or incompletely (e.g., when forgetting to install mid-point strain relief devices).

It is therefore a principle object, feature, advantage, or aspect of the present invention to improve over the state of the art and/or address problems, issues, or deficiencies in the art.

Envisioned are apparatuses, systems, and methods of providing stability and protection to long runs of conductor wire, and in a manner that improves upon the state of the art by reducing both potential cost (e.g., by eliminating mid-point pole handholes) and potential error in installation (e.g., by reducing steps or connection points required of a contractor/installer).

In one aspect of the invention, a method for creating a wire support system for a run of conductor wire comprises winding, braiding, or twisting one or more conductor wires together with a support wire to create an intermediate wire bundle to minimize interaxial gaps between any of the one or more conductor wires or between any of the one or more conductor wires and the support wire; wrapping the intermediate wire bundle with a tape to create a final wire bundle; cutting the final wire bundle to a desired length having opposite ends; and clamping a sleeve along the length of and around the cut final bundle at or near both of the opposite ends of the cut final wire bundle.

In another aspect of the invention, an apparatus comprises a wire support system comprising a run of one or more conductor wires wound, braided, or twisted together with a support wire to create a wire bundle to minimize interaxial gaps between any of the one or more conductor wires or between any of the one or more conductor wires and the support wire.

In another aspect of the invention, the apparatus above could further comprise a spiral wrap of the wire bundle with a tape to bind the bundle along its length.

In another aspect of the invention, the apparatus of a twisted bundle of conductor and support wires, wrapped with tape, could further comprise a clamping sleeve at one or both ends of the run to hold the twisted wires from longitudinal axially movement relative to one another.

In another aspect of the invention, the apparatus can be incorporated into a combination of a structural member with a stabilizing point, the twisted and/or wrapped wire bundle connected to the stabilizing point, and the opposite ends of selected wires of the wire run operatively connected to first and second electrical devices. In one example, the first and second electrical devices are lighting fixtures and electrical power, respectively, or a sensor device (e.g., light, moisture) and a receiving device (e.g., radio, gateway, processor), respectively.

In another aspect of the invention, the apparatus can be included in a plurality of structural members. One example is a plurality of poles with elevated lighting fixtures at spaced apart positions around a common illumination target, such as a sports field, each lighting fixture having an associated wire support system, all the wire support systems run to a common location (e.g., power distribution cabinet).

These and other objects, features, advantages, or aspects of the present invention will become more apparent with reference to the accompanying specification and claims.

### BRIEF DESCRIPTION OF THE DRAWINGS

From time-to-time in this description reference will be taken to the drawings which are identified by figure number and are summarized below.

FIG.1A-C illustrate a typical large scale, outdoor lighting application which employs long runs of conductor wiring and may benefit from aspects of the present invention. FIG. 1A illustrates a typical target area with pole layout (each pole 6 including one or more lighting fixtures 2); FIG. 1B illustrates one such pole enlarged and in isolation (and showing optional additional electrical enclosures 13); and FIG. 1C illustrates one such pole greatly enlarged, in isolation, and showing two possible geographically remote devices (power means 3 contained in electrical enclosure 13 and lighting fixtures 2) which are connected via one or more of said longs runs of conductor wires 14 (here illustrated by dashed lines as only one conductor wire for clarity) internally routed through one or more pole sections 6 to one or more crossarms 7 and knuckles 4 at a poletop position (in FIG. 1C pole cap 20 is removed for clarity).

FIGS. 2A and B illustrate partial cutaways of side views of FIGS. 1B and 1C, respectively; note that for clarity no section lines are shown. FIG. 2A illustrates one possible means of supporting conductor wires according to state-of-the-art practices; FIG. 2B illustrates another possible means of supporting conductor wires according to state-of-the-art practices.

FIGS. 3A-E illustrate multiple views of another possible means of supporting conductor wiring according to state-of-the-art practices. FIG. 3A illustrates a typical side view with partial cutaways (note section lines have been omitted for clarity), FIG. 3B illustrates one possible means of connecting geographically remote devices according to Detail A of FIG. 3A (here electrical connector halves 23/24 are shown disconnected but in practice form an electrical connector when brought into operative electrical connection), FIG. 3C illustrates conductor wiring 14 (here illustrated as only one conductor wire for clarity) in isolation and with associated connection devices and strain relief means, FIG. 3D illustrates typical conductor wire spacing within conventional conductor wire management systems according to Section A-A of FIG. 3C (note section lines have been omitted for clarity), and FIG. 3E diagrammatically illustrates a typical pitfall of conventional conductor wire conduit in which a cross-sectional profile illustrates distortion by pinching conductor wires (note section lines have been omitted for clarity).

FIGS. 4A-I illustrate multiple views of a first embodiment of a wire support system according to aspects of the present invention along with associated method of production. FIG. 4A illustrates a perspective view with multiple partial cutaways (and pole cap 20 exploded off from pole 6, yet secured to stabilizing point 21 via device 29), FIG. 4B illustrates conductor wiring 14 (here illustrated as only one conductor wire for clarity) in isolation and with associated connection devices and strain relief means, FIG. 4C illustrates compact conductor wire bundling along the nylon-bound section according to Section B-B of FIG. 4B (here nylon binding 30 is shown greatly enlarged in thickness for clarity, with all section lines omitted), FIG. 4D illustrates Detail B of FIG. 4B (with a partial cutaway of connector half 23, with section lines omitted), and FIG. 4E illustrates conductor wire spacing at aluminum sleeve 31 section according to Section C-C of FIG. 4B (here nylon binding 30 is shown greatly enlarged in thickness for clarity, with all section lines omitted). FIG. 4F illustrates in enlarged scale one end of an isolated twisted bundle of individual conductor wires 14 and support wire 26 from FIGS. 4A-E; FIG. 4G diagrammatically illustrates the direction of twisting of the intermediate bundle of FIG. 4F. FIG. 4H illustrates the intermediate bundle of FIG. 4F as wrapped (in opposite direction) with nylon tape 30. FIG. 4I illustrates one possible way a mechanized system could apply tape 30 to bundle 14/26; here taken from U.S. Pat. No. 9,887,025, incorporated by reference herein.

FIG. 5 illustrates one possible method of creating a wire support system such as that illustrated in FIGS. 4A-E, including both stability and protective means according to aspects of the present invention.

FIG. 6 illustrates one possible method of installing a wire support system as produced according to the method of FIG. 5 in the lighting system of FIGS. 1A-C according to aspects of the present invention.

### DETAILED DESCRIPTION OF EXEMPLARY EMBODIMENTS

### A. Overview

To further an understanding of the present invention, specific exemplary embodiments according to the present invention will be described in detail. Frequent mention will be made in this description to the drawings. Reference numbers will be used to indicate certain parts in the drawings. Unless otherwise stated, the same reference numbers will be used to indicate the same parts throughout the drawings.

Regarding terminology, reference is given herein to power means and lighting fixtures as examples of geographically remote devices which may benefit from aspects according to the present invention; here “geographically remote” can mean a distance of a few inches or many dozens of feet, or some other greater distance, for example. Geographically remote devices can be other than power means and lighting fixtures as well; geographically remote devices could be a receiver coupled with a sensor or other device which communicates a signal to the receiver, or power means with a control circuit, for example. Reference is also given herein to the “top” of a pole and the “bottom” of a pole, the former also being referred to herein as the “distal end” and the latter also being referred to herein as the “proximate end”; it is important to note that these terms are relative to the application and orientation of wires, devices, etc., and none are intended to impart any limitations not explicitly stated herein. For example, an application may not use a pole at all (e.g. using instead some other sort of structural member such as a truss), or an application may run wire in a horizontal direction and therefore have a “left” and “right”, but no “top” and “bottom”. All are possible, and envisioned, according to aspects of the present invention.

Further regarding terminology, terms such as “device”, “component”, “means”, “portion”, “part”, and “apparatus” may be used herein to describe various aspects according to the present invention, any of which might be combined or otherwise form part of a larger system. While specific reference is given herein to protective means, some examples of which are tubing and conduit, and specific reference is given herein to stability means some examples of which are strain relief, in situ positioning, and bundling, generally speaking, the aforementioned terms are used by way of convenience, and none are intended to impart any limitations not explicitly stated herein.

With further regards to terminology, it is important to note that terms such as “tape”, “wrap”, and “tape wrap” are used interchangeably herein to describe a part (see reference no. 30); this is for purposes of illustration, example, and to cover a variety of manners in which said part might be referenced in industry. This is true also of the terms “contractor’” and “installer” as examples of those who may practice the invention; again, these are non-limiting examples using different terms that one may encounter in industry. This approach to terminology can be further extended to the use of the terms “conductor”, “wire”, “wires”, “cable” and “wiring”. While specific reference is given to “conductor wire” or “conductor wiring” (see reference no. 14) which is electrically conductive effective for such things as electrical power or current transmission (including low voltage or high voltage), control or signal transmission, data transmission, multiplex transmission (including power and signal transmission simultaneously), or other electrically interconnecting functions, and while specific reference is given to “support wire” (reference no. 26) to denote a wire, strand, elongate, or multi-strand that exhibits one or more of strength and durability over large temperature range, resistance to corrosion, and resistance to abrasion both of itself and of surfaces or components it may come into contact (but is not required to conduct power or a signal), generally speaking, the aforementioned terms are used by way of convenience, and none are intended to impart any limitations not explicitly stated herein.

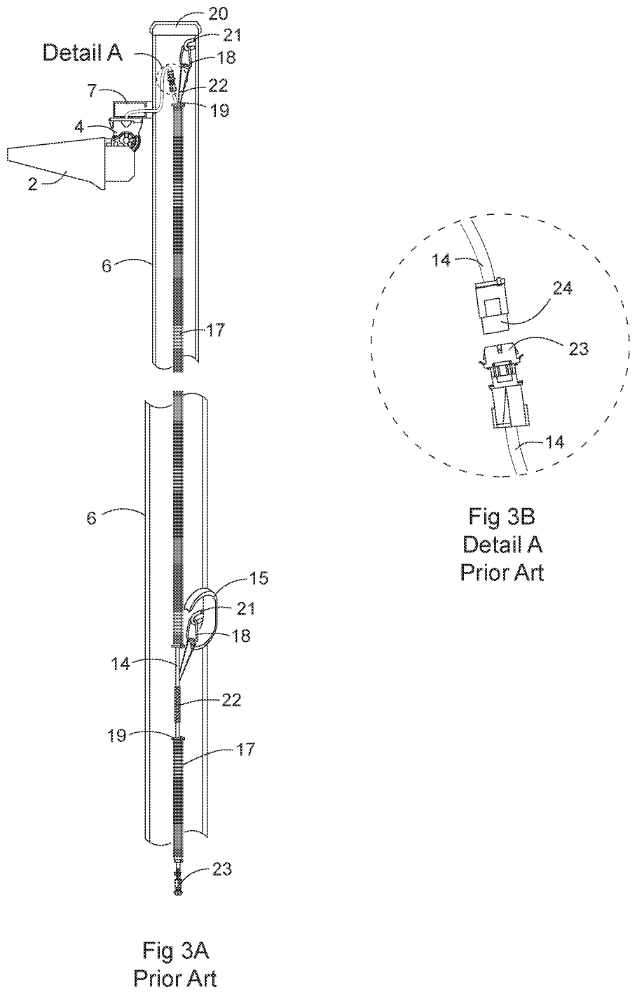

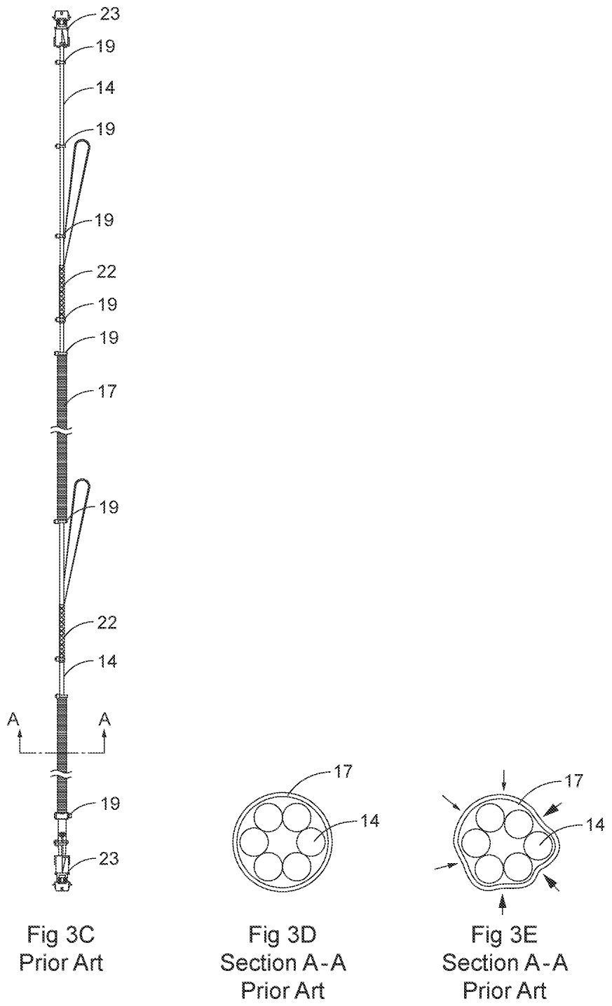

However, it is of note that irrespective of which term is used to describe what is understood in the industry as a slender rod or filament of material (often drawn material), the figures typically illustrate for clarity a single wire. That being said, a wire could be a single wire or multiple wires, one or more wires including multiple strands, or even wire-like components (e.g., fiber) in any material, bundling arrangement, or gauge. Wire can be bare or surrounded by another layer or layers of material (e.g. shielding, insulation, jacketed, coated, etc.). Said wires could be very long (e.g., many dozens of feet) or simply an inch or so, and may be referred to as “runs” and “bundles” regardless of length, number of wires, etc. Also, with respect to said runs or bundles of wiring, the term “gap” is used herein; this term generally refers to an interaxial spacing that is more than slight separations between the cross-sectional perimeters of adjacent wires. In essence, a gap in a wire bundle refers to larger separations where one or more wires are not in abutment with other wires or an enclosure in all transverse directions, examples of which are shown in FIGS. 3D and E. Of course, other terms (e.g., “void”) might describe the same phenomenon, what generally constitutes a “gap” might differ from application to application (e.g., depending on a ratio of empty space to wire across a bundle cross-section). All of the aforementioned terms and options are possible, and envisioned.

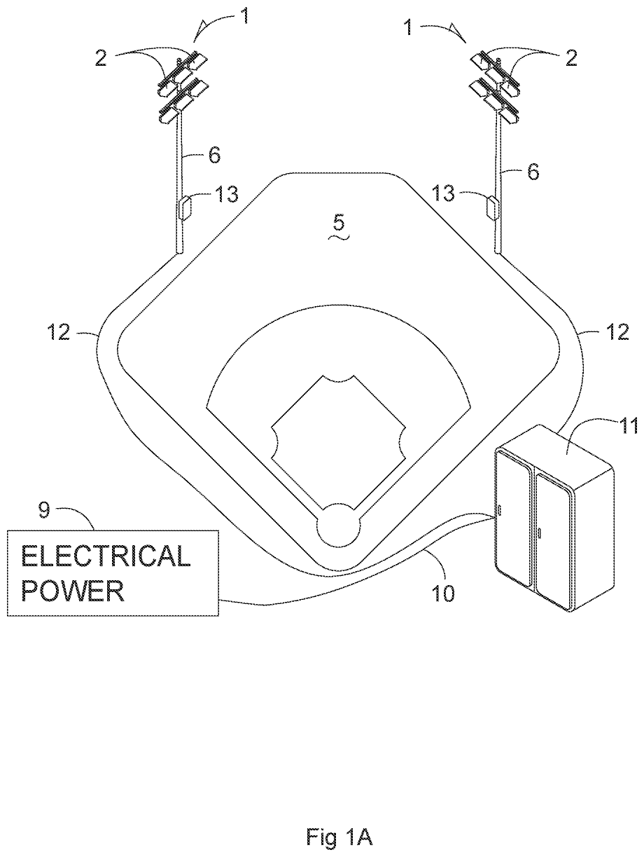

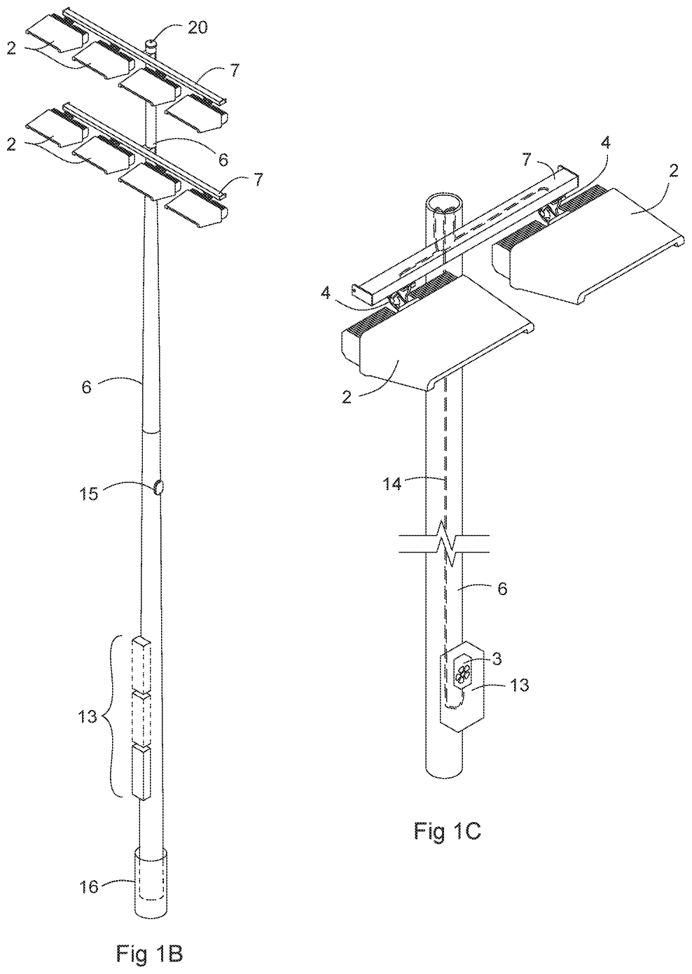

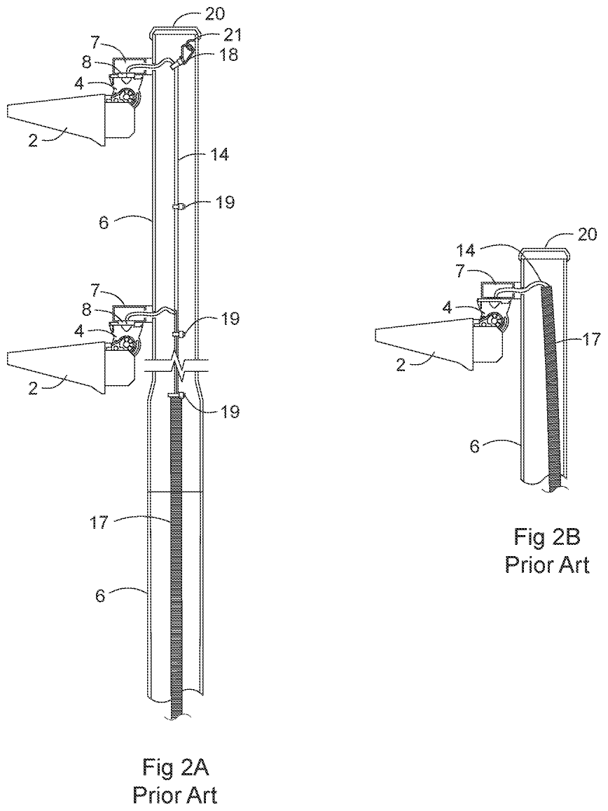

Returning now to the outdoor lighting application of FIGS. 1A-C, consider how conductive wiring is stabilized and protected according to state-of-the-art practices; this is illustrated in FIGS. 2A and B. As can be seen from FIG. 2A, conductive wire (also sometimes referred to as a conductor) 14 is routed along the internal space of hollow pole sections 6 and isolated at different points to be routed through hollow crossarms 7 to power lighting fixtures 2 at connection points 8 which are embedded in knuckles 4; additional information regarding making electrical connections at knuckles (also referred to as adjustable armatures) can be found in U.S. Pat. No. 8,337,058 incorporated by reference herein. Multiple conductive wires may be bundled via cable ties 19 and protected via flexible or semi-rigid conduit 17 (e.g., any model of corrugated tubing available from OEM/Miller, Aurora, Ohio, USA). Some degree of strain relief might be provided by affixing a cable tie 19 to a stabilizing point 21 via a snap-type hook 18 (e.g., any commercially available stainless steel snap hook with sufficient loading capacity (e.g., ˜250 lbs)). In other situations, no strain relief may be present; this is illustrated in FIG. 2B, which is a side view in partial cutaway of the pole and lighting fixture arrangement of FIG. 1C. Of course, no strain relief means (as in FIG. 2B) is not preferable for long runs of conductive wire, nor is a strain relief means that places significant stress on a single point of a conductive wire (as in FIG. 2A).

FIGS. 3A-E illustrate an improvement over the systems of FIGS. 2A and B, but a state-of-the-art approach that is not without deficiencies. As can be seen from FIGS. 3A and C, additional support for conductive wiring can be provided by extending conduit 17 along more of the length of pole 6; this can be in addition to bundling via cable ties 19. In this sense, a more stable and protected run of conductive wire exists from the top of the pole to the bottom of the pole. In terms of strain relief, strain relief means 22 are an improvement insomuch that stress is spread out across conductor wires 14 (i.e., via a wire matrix which encloses all conductive wires and terminates in a loop which is hooked to stabilizing point 21 via snap-type hook 18) rather than at a single point (as in FIG. 2A).

While the wire support system of FIGS. 3A-E is certainly an improvement over the systems illustrated in FIGS. 2A and B for long runs of conductive wire, in the event a contractor forgets to attach strain relief means 22 at the pole mid-point (see handhole 15 of FIG. 3A), strain relief means 22 at the poletop position can actually become overloaded and cut into the insulation of conductor wires 14 and ultimately, cause device and/or conductive wiring failure. Additionally, conduit 17 which is intended to provide stability by keeping conductive wire bundles intact and improve the ease of in situ positioning can actually decrease the integrity of the conductive wiring in some situations. If conductive wire bundles have a gap (as in FIG. 3D where the entire cross-sectional area inside conduit 17 is not substantially occupied by conductive wire(s), in this example leaving a gap in the middle, or otherwise where the interaxial spacing between any conductor wires 14 in the conduit 17 has gaps such that the conductor wires 14 are not all in abutment with other conductive wires or any encasement (e.g., conduit 17) in all directions), conductive wires can be damaged (e.g., pinched as in FIG. 3E) when uneven forces are applied to the conductive wire bundle (e.g., when pulling through a pole or crossarm or when isolating conductive wire sections at the top of the conductive bundle to power lighting fixtures).

So as can be seen, state-of-the-art practices can be improved upon with respect to wire support systems. By way of convenience and comparison, and not by way of limitation, the following discusses exemplary apparatuses, systems, and methods which set forth such improvements in the context of a large scale, outdoor sports lighting system such as that illustrated in FIGS. 1A-C.

### B. Exemplary Method and Apparatus Embodiment 1

A first embodiment according to aspects of the present invention addresses improved stability and protection of long runs of conductive wiring by reducing the number of strain relief connection points thereby providing a potential cost savings (e.g., by eliminating a handhole) and reducing potential installation error, with improved bundling which, among other benefits, reduces friction.

Apparatus

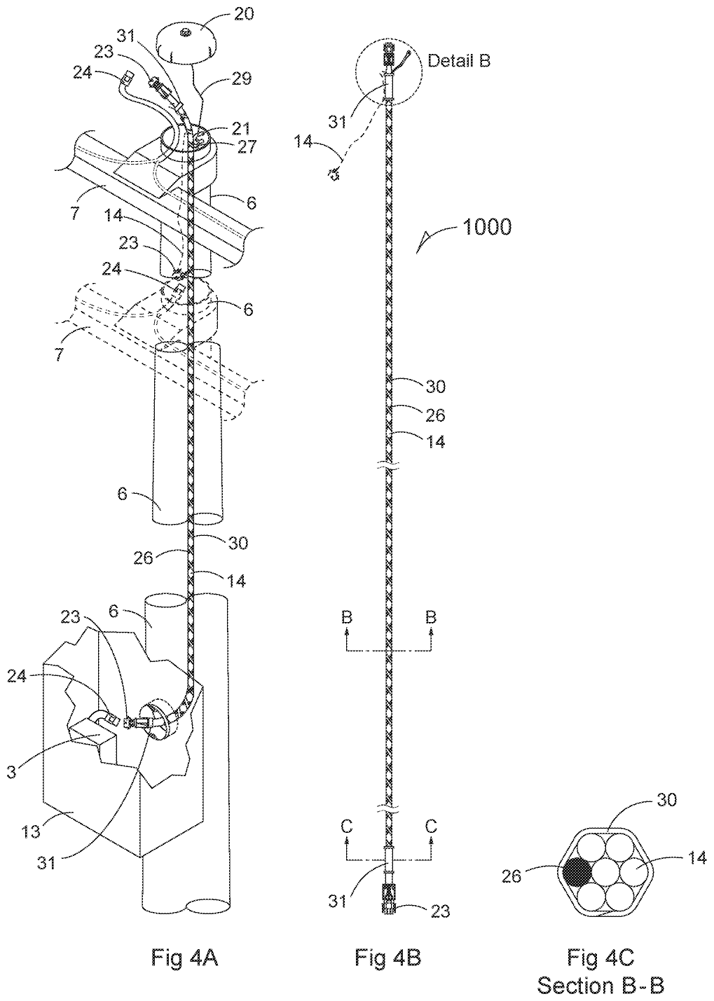

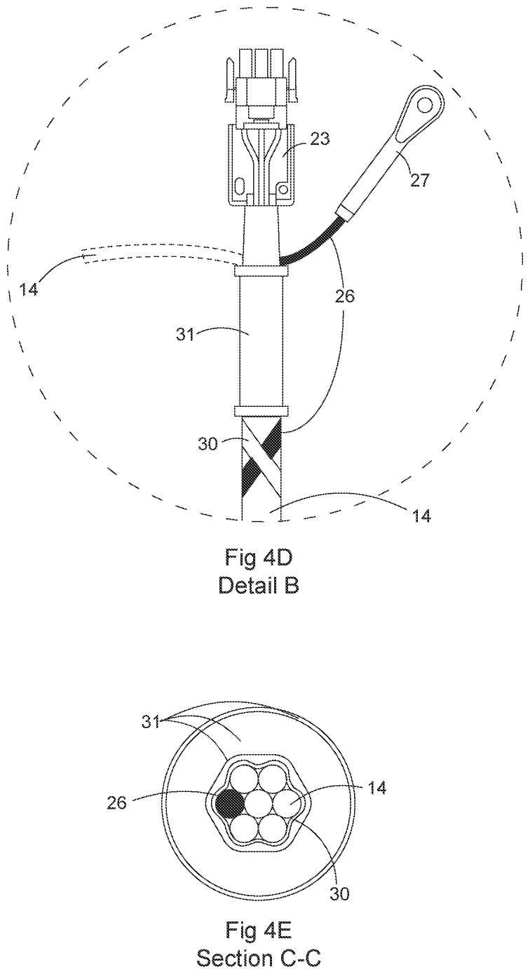

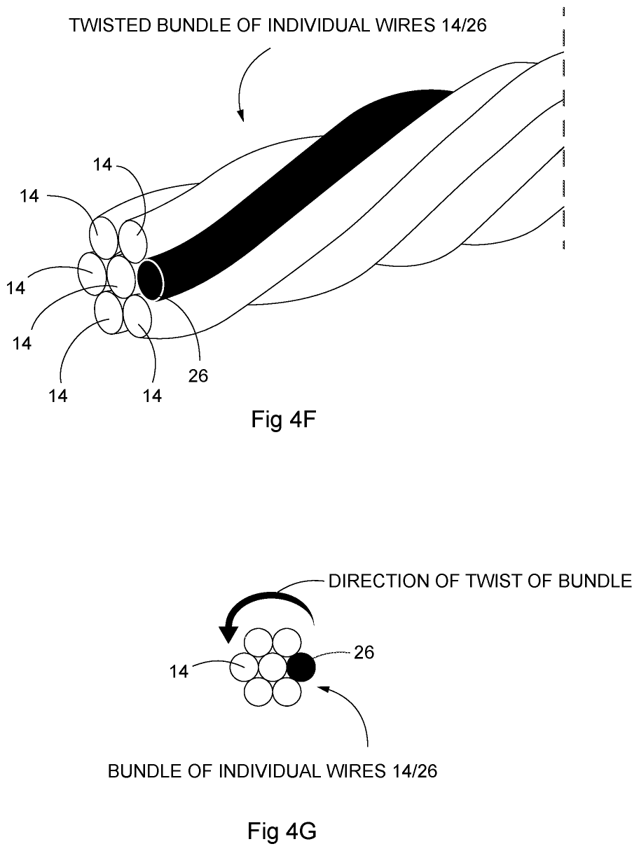

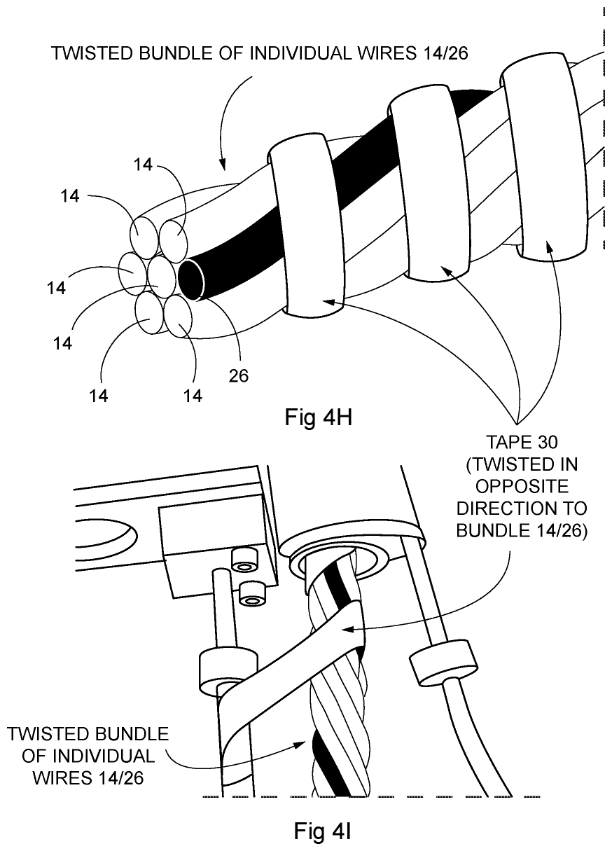

According to the present embodiment and with particular reference to FIGS. 4A-I, a support wire 26 (e.g., any nylon coated 304 stainless steel wire)—which unlike conductor wiring 14 is not designed to carry power or a signal—is placed at or near the perimeter of a group of conductor wires 14 so to create a preliminary wire bundle. Support wire 26 and conductor wires 14 are wound, braided, or otherwise twisted together (at least in some cases), run at least a substantial length of a pole 6, and connected to aforementioned stabilizing point 21 via an eye end fitting 27 (e.g., any stainless steel model available from Loos & Company Inc. Cableware Division, Naples, Fla., USA). The placement of support wire 26 together with the winding efforts provides both improved protection and stability—as opposed to burying support wire 26 in the center of intermediate bundle 14/26—since (i) with regards to the former, more of the overall exterior surface area of the run of intermediate bundle 14/26 is support wire 26, and so in the event of a sharp or abrasive surface (e.g., in the interior of a pole) it is more likely support wire 26 will absorb the damage than conductor wires 14; and (ii) with regards to the latter, more support wire 26 is used and its position in intermediate bundle 14/26 is varied over the increased run length of the bundle, which allows more distribution of forces along the run of the bundle. The pitch, slope, and radius of the helical or spiral twisted wire can vary according to the wire and its application, and the direction of twist into the helical or spiral shape can be either right-handed or left-handed. In the case of braiding (not illustrated) the tightness and type (e.g., single, double) of the braid can vary according to the wire, number of wires, and its application.

Protection and stability can be further enhanced by then wrapping intermediate bundle 14/26 with a component or material that at least partially covers and may also cinch or provide inward radially forces to reduce or hold individual conductor wires 14 and 26 of bundle 14/26 together without any gaps. In this embodiment wrap 30 is a flat braided nylon tape (e.g., model NOF150W available from Western Filament, Inc., Grand Junction, Colo., USA—minimum break 135 lb., elongation 40%, width 0.180 inch min. to 0.220 inch max., thickness 0.013 inch min. to 0.019 inch max., melts at 480° F. to 500° F., excellent resistance to mildew, aging, and abrasion) so to create a final bundle; as can be seen in FIGS. 4A, B, D, H, and I tape wrap 30 in this embodiment is wound in the opposite direction (e.g. left-hand direction if support wire 26 twist is right-handed direction; right-hand direction if support wire 26 is left-handed) of support wire 26 around the outside/perimeter of the bundle (thereby creating two opposite-running spirals or helixes). Again, the pitch, slope, and overlap or spacing of turns of the helical or spiral wrap 30 can vary according to the bundle that is being wrapped, the wrap itself, and the application. Likewise, if braiding tape 30 into bundle 14/26 the tightness and type (e.g., creating a rope braid if intermediate bundle 14/26 is twisted together, creating a double braid if bundle 14/26 is braided together) of the braid can vary according to the wire, number of wires, and its application.

In the example illustrated in FIGS. 4A-I, the helical or spiral pitch relative to tape width is such that there is no overlap of tape edges, and portions of support wire 26 are exposed, though tape 30 could have edges closer or even overlapping, if desired or needed. Irrespectively, both ends of final bundle 14/26/30 are run through the center of a sleeve 31 (here, as a non-limiting example, a cylindrical aluminum sleeve having a thickness on the order of 0.10″ surrounding a rubber sleeve/grommet having a thickness on the order of 0.10″ with an overall length on the order of 2.25″ and an inner diameter (i.e., aperture) on the order of 0.35″) which is then crimped in place thereby securing tape 30, support wire 26, and conductor wires 14 in situ and preventing unraveling of any component. Sleeve 31 provides sufficient radial forces to resist any longitudinal movement of individual conductor wire(s) 14 or support wire 26 relative to others in the bundle. It essentially is a mechanical clamp to hold all wires in the bundle in that same longitudinal position relative to each other. Any final connectors 23, 24 are added to either or both ends of component 14/26/30/31 so to create an envisioned wire support system 1000.

As can be seen from FIGS. 4A-I friction is reduced because twisted bundled conductor wires 14 are bound along substantially the entire length (with the exception of a secondary length, later discussed) and do not rub against one another even when one or more conductor wires 14 are split off (e.g., by keeping all wires fixed at a common point at the top and bottom of the pole); note that in FIGS. 4A, B, and D twisted bundled conductor wires 14 are not individually shown for clarity, but support wire 26 is shown to illustrate its relative position along the twisted wire bundle 14 and its direction of twist. Also, there is no pinching or distortion of wires (as may be the case in using conduit of a fixed size/diameter) since support wire 26 and tape 30 conform to the shape of conductor wires 14, and in any event are fixed at sleeve 31 (thereby also ensuring compact bundling). Tape 30 is shown individually to illustrate its relative position along twisted conductor wires 14 and support wire 26, as well as its different direction of twist. As can be seen, wrap 30 does not necessarily cover all of twisted intermediate bundle 14/26; this can aid in providing binding to avoid gaps, make the bundle easier to handle (e.g., by adding some rigidity which makes pulling runs of wiring easier), and protect the bundle, but also save costs by less wrap material in final bundle 14/26/30. Lastly, strain relief means are provided along the entire length, yet only one connection (see reference no. 27) need be made by a contractor—this eliminates the need for handhole 15 (see FIG. 3A).

As will be appreciated by those skilled in the art, benefits according to one or more aspects of the invention could be achieved by the following combinations in addition to what has already been described and illustrated:
a. Just one or more conductor wires 14 with a support wire 26 twisted along the longitudinal length of the assembly. If the one or more conductor wires 14 is more than one wire, they might not be twisted but rather simply be parallel, but support wire 26 twisted around them. As such, this combination provides a support wire 26 along the length for strength and durability, but does not use wrap 30 or sleeves 31.
b. One or more conductor wires 14 with support wire 26 and wrap 30, without sleeves 31. This combination provides support wire 26 for its purposes but adds wrap 30 to pull together the bundle 14/26 along its length, adds rigidity, and provides anti-friction areas along the length.
c. One or more conductor wires 14 with support wire 26 and wrap 30, with a sleeve 31 at one end of the length. This combination provides support wire 26 and wrap 30 for their purposes, but adds at least one sleeve 31 at an end of the length for its assistance in deterring longitudinal movement of individual conductor wires 14 in the bundle relative to others, and allowing one or more wires 14/26 in the bundle to extend from the sleeve as discussed in the exemplary embodiments.
d. One or more conductor wires 14 and support wire 26 and at least one sleeve 31, but not wrap 30. This combination provides support wire 26 with at least one sleeve 31 for their purposes but without wrap 30.

As indicated, the combination of all features can provide enhancements individually and collectively, but combinations of less than all features are possible according to need or desire.

Method

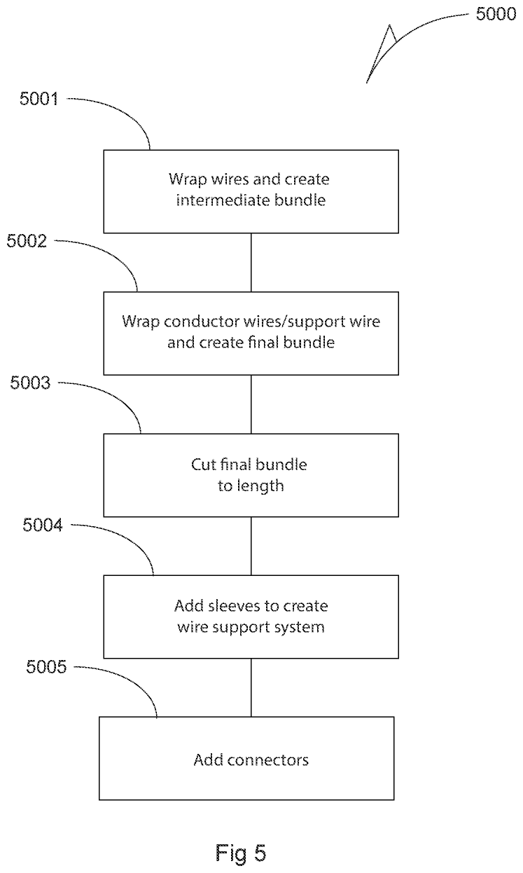

In practice, wire support system 1000 of FIGS. 4A-I may be produced according to method 5000 of FIG. 5. According to a first step 5001 conductor wires 14 are gathered along with a support wire 26; the precise number, gauge, and material of wires 14/26 will depend on the application, number of geographically remote devices being connected, etc. In this embodiment, conductor wires 14 and support wire 26 are gripped and twisted as they are fed from their respective spools. This intermediate bundle is then gripped and wrapped in a similar fashion (but in opposite direction) with nylon tape 30 according to step 5002, thereby creating a final bundle having two opposite running spirals and no gaps between wires. In practice, the same machine is used for steps 5001 and 5002—and depending on fabrication capabilities, steps 5001 and 5002 could be done more or less concurrently.

According to a third step 5003, final bundle 14/26/30 is cut to a defined length. Here care must be taken to not only account for the length needed between geographically remote devices (e.g., fixtures 2 and power means 3), but also (i) an extra length of conductor wires 14 to extend out of sleeve 31 so to make necessary connections, and (ii) a length of support wire 26 so to allow for connection for strain relief (see, e.g., see exposed portion of support wire 26 connected to fitting 27, FIG. 4D, which is placed in operative connection with part 21 to provide strain relief). In the case of a single crossarm or geographic location, extra length of conductor wire 14 may be a fraction of an inch (see, e.g., small amounts of conductor wires 14 in connector half 23, FIG. 4D). For the example of devices on a lower crossarm or multiple geographic locations (see, e.g., pole 6 and crossarm 7 in broken line in FIG. 4A), extra length of conductor wire 14 may be many inches long (see, e.g., conductor wire 14 in broken line in FIGS. 4A and B). Though the exact length of components may vary from application to application, in all cases final bundle 14/26/30 has a primary length running the span of a pole, and splitting off (if any) of any of wires 14 and/or 26 for connections or otherwise (i.e., a secondary length) is done after strain relief means at the pole top (unlike in some state-of-the-art practices).

When an adequate length of final bundle is measured and cut, both ends of said primary length are fitted with sleeves 31 and secured by crimping (e.g. using hand force with manually-operated tools or with automatic or semi-automatic tools or machines) (step 5004)—the goal being to secure wires, but not to pinch wires as in FIG. 3E, and to leave sufficient length of wires 14/26 (e.g., for connectors, for running to different locations for connection to geographically remote devices). The correct amount of pinching can be established by trial and error, and is dependent upon the physical characteristics of sleeve 31 and the physical characteristics of wires 14 and 26.

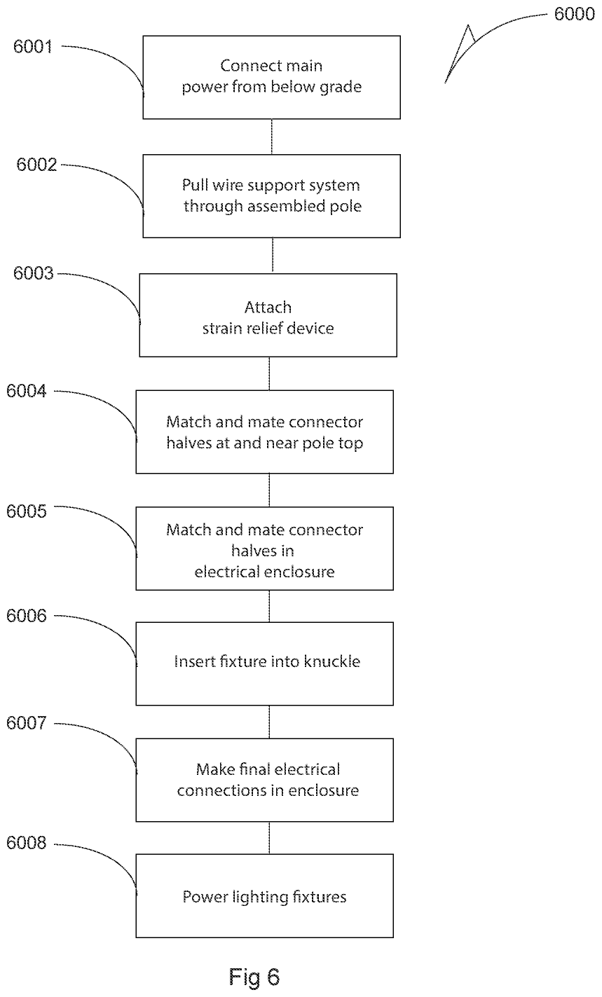

As a final step 5005, connectors and/or connector halves (see, e.g., reference nos. 23/24) and/or fittings (see, e.g., reference no. 27) are connected to portions of selected wires 14/26 extending past sleeves 31, and wire support system 1000 is ready for use in a variety of applications; FIG. 6 illustrates one possible method 6000 of implementation for the specific case of a large scale, outdoor lighting system such as that illustrated in FIGS. 1A-C.

As a first step 6001, power wiring 12 is connected below grade at a pole location (e.g., at base 16, FIG. 1B) where a substantially hollow pole 6 is to be assembled and installed; typically pole 6 is laid horizontally on the ground near base 16 at this early stage. Following this, wire support system 1000 is pulled through pole 6 (e.g., via commercially available fish wire-type wire pulls)—step 6002. At this point in situ positioning is secured, at least in part, by attaching strain relief device 26/27 to stabilizing point 21 (step 6003); note that this is the only strain relief (and snap-hook type) connection required of a contractor, and that there is a visual cue to complete the connection by presence of strain relief device 26/27 when a contractor accesses connectors via pole cap 20 (unlike the mid-point strain relief device of the prior/current art which provides no such visual cue when pulling wire).

Once wire support system 1000 is pulled and positioned, a distal end (i.e., the end at or near pole top) is connected to mating connector halves 23/24 (see FIG. 4A) according to step 6004; similarly, a proximate end (i.e., the end at or near the bottom of the pole) is connected to connector halves 23/24 according to step 6005. Again, if there are multiple connections to be made along the vertical length of the pole (e.g., lighting fixtures on lower and upper crossarms), each conductor wire 14 (which will likely be labeled with some indicia on or near its connector half which matches up with indicia on its mating connector half at or near knuckle interface 8) must be isolated and routed accordingly. This is likewise true at the proximate end where connector halves may need to be mated at specific drivers or landed at specific ports in enclosure 13. As a result, there may be different lengths of wires 14/26 extending outwardly from sleeve 31 at either end of wire support system 1000; put differently, the secondary length (i.e., the length of conductors past sleeve 31) could, in practice, vary depending on the number and purpose of wires 14/26.

A full electrical connection is made at the distal end when fixtures are snapped into place according to step 6006 (see again U.S. Pat. No. 8,337,058 for details); of course, if the application is different (e.g., connecting a cellular antenna at a top of a pole to a control device at the bottom of a pole) step 6006 could be different, or omitted entirely. At this point pole 6 (which to this point has been lying on the ground) is stood, elevated, and placed on pole base 16 as in FIG. 1B. Final electrical connections (e.g., landing main power at a main disconnect) are made at the proximate end (step 6007) to complete the circuit and, ultimately, connect geographically remote devices (which in one example, results in powering plural (e.g., three) lighting fixtures 2 (step 6008)). Method 6000 would then be repeated for each pole location at each target area until all lighting fixtures are connected and powered.

As will be appreciated by those skilled in the art, methods 5000 and 6000 could be modified in any of the ways discussed in the Apparatus section, supra. For example, embodiments of the invention may not include twisting of conductor wires 14, use of wrap 30, use of sleeve(s) 31, or could include some or all of them.

C. Options and Alternatives

The invention may take many forms and embodiments. The foregoing examples are but a few of those. To give some sense of some options and alternatives, a few examples are given below.

Several figures illustrate wiring 14 or 26 as a single wire, but it is important to note that aspects according to the present invention could be applied to a single wire, multiple wires, wires of varying materials and gauges, wires intended to power devices, wires intended to carry a signal (even if referred to as a conductor), or wires intended to both power devices and carry a signal (e.g., powerline communications). Both conductor wire 14 and support wire 26 can very in gauge, length, material, quantity in a bundle—and may be braided, wound, twisted, or some combination thereof (e.g., conductor wires twisted to each other and then braided with one or more support wires 26).

Cross-sections of devices have illustrated some parts as greatly exaggerated in thickness; for example, in part 30 of FIG. 4C. It is important to note that in addition to wires 14/26, these other parts may differ in quantity, thickness, and shape—and that aspects according to the present invention could be applied to all. Further, while geographically remote devices have been illustrated as including lighting fixtures and remotely located power means, aspects of the present invention could apply to other electrical devices (e.g., antennas, radios, communication stations, monitors, computer towers). Also, connection means have been generally illustrated herein as a hook with associated device (e.g., eye end fitting), but any means of connecting a wire bundle to a point could be used (e.g., a loop of support wire 26 hooked on hook 21). As another example, poles 6 could be formed from multiple sections or be a single section, may be only a few feet tall or many feet tall, and include a taper or be slip-fit, or otherwise—or in some cases may not be a pole or have hollow support members (e.g., a solid bar truss). As yet another example, various stability and protection means could be combined; for example, a primary length of wiring may be such as described in Embodiment 1, but a secondary length of wiring may be secured with cable ties (as is common in the state of the art). All of the aforementioned options are possible, and envisioned, according to aspects of the present invention.

It is also important to note that an application benefitting from aspects of the present invention may be other than a large scale, outdoor lighting application, and that methods 5000 and 6000 may differ accordingly. Depending on the needs of the application, the type of wiring, and the nature of the geographically remote devices being connected (as an example), methods 5000 and 6000 may include more, fewer, or different steps than those illustrated and described herein. For example, method 6000 may omit step 6006 if the electrical device does not require an intermediate connection point (see reference no. 8). As another example, at least some wires 14/26 in a final wire bundle may not have any connectors connected according to step 5005, and therefore steps 6005 and 6007 may be omitted for at least some wires 14/26. This may be useful, for example, if there is not a current need for a conductor wire, but there is an anticipated future need for the conductor wire (e.g., if adding lighting fixtures or poletop sensors like photocells); in this sense the conductor wires need only be bundled and run once but connectors could be added as needed—even well after installation—without compromising the integrity of the bundle or having to re-run wiring again.

Even if the application is a lighting application (indoor or outdoor, large scale or small scale), methods 5000 and 6000 may differ from that described and illustrated herein. For example, steps 6001, 6004, and 6005 could be reordered for a more intuitive approach to completing an electrical circuit. As another example, a pole may be stood up and installed prior to pulling wires (i.e., occurring before step 6002 instead of before step 6007 as described). Again, all of the aforementioned are possible, and envisioned, according to aspects of the present invention.

What is claimed is:

1. A method for creating a wire support system for a run of conductor wire comprising:
a. winding, braiding, or twisting one or more conductor wires together with a support wire to create an intermediate wire bundle to minimize interaxial gaps between any of the one or more conductor wires or between any of the one or more conductor wires and the support wire;
b. wrapping the intermediate wire bundle with a tape to create a final wire bundle;
c. cutting the final wire bundle to a desired length having opposite ends; and
d. clamping a sleeve along the length of and around the cut final bundle at or near one or both of the opposite ends of the cut final wire bundle.

2. The method of claim 1 wherein the step of winding, braiding, or twisting is in a first direction, and wherein the step of wrapping with tape is in a second direction.

3. The method of claim 2 wherein the step of winding, braiding, or twisting in the first direction and the step of wrapping with tape in the second direction produces two opposite running spirals along at least a portion of the wire support system.

4. The method of claim 1 wherein the step of clamping the sleeve at or near one or both ends of the cut final wire bundle comprises running the cut final wire bundle through an aperture of the sleeve and crimping the sleeve to secure the final wire bundle in situ.

5. The method of claim 1 further comprising affixing a fitting to an end of the support wire of the secured final wire bundle, said fitting adapted to be used for strain relief.

6. The method of claim 1 further comprising affixing a connector or connector half to both ends of the one or more conductor wires of the secured final wire bundle, said connector or connector half adapted to transmit electrical power or a signal.

7. A wire support system having a defined length and opposite ends comprising:
a. one or more conductors;
b. a support wire bundled and twisted or braided with said one or more conductors;
c. a tape twisted around said bundled and twisted or braided support wire with one or more conductors; and
d. a sleeve compressing the tape and support wire with one or more conductors at or near each of the opposite ends.

8. The wire support system of claim 7 further comprising electrical connectors or connector halves connected to at least one of the one or more conductors at each of the opposite ends.

9. The wire support system of claim 7 further comprising a fitting at one of the opposite ends adapted to connect the support wire to a device to provide strain relief of the one or more conductors.

10. The wire support system of claim 7 wherein one or more of the conductors has a length that extends past the sleeve at one of the opposite ends, and wherein the defined length of the wire support system comprises a primary length including said one or more conductors, support wire, and tape, and a secondary length including said one or more conductors which extend past the sleeve.

11. A combination of first and second electrical devices in operative electrical connection by one or more conductor wires comprising:
a. a structural member having a stabilizing point;
b. an electrical connector for the first electrical device;
c. an electrical connector for the second electrical device;
d. a run of a twisted or braided bundle of the one or more conductor wires and a support wire wrapped with a tape, the run having a length between opposite ends, each opposite end having an electrical connector adapted for operative electrical connection to one of the electrical connectors of the first or second electrical devices; and
e. a wire support system comprising:
i. the run of the twisted or braided bundle and wrapped tape for reducing interaxial gaps between the one or more conductor wires and the support wire; and
ii. a fitting connected between the support wire and the stabilizing point of the structural member for strain relief of the run.

12. The combination of claim 11 wherein the wire support system further comprises a sleeve clamped around the run of the twisted or braided bundle and wrapped tape along the length of and near one end of the run.

13. The combination of claim 11 wherein:
a. the structural member is a hollow pole and the stabilizing point comprises a connector inside the hollow pole;
b. the first electrical device comprises one or more lighting fixtures elevated on the hollow pole;
c. the second electrical device comprises:
i. a source of electrical power;
ii. a source or receiver of an electrical signal;
iii. a source of electrical power and a source or receiver of an electrical signal; or
iv. a control circuit.

14. A lighting installation comprising a plurality of the combinations of claim 11 emplaced at spaced apart locations around a common target area.

15. The lighting installation of claim 14 wherein the hollow pole of each said combination when installed is dozens of feet in length, and the run of twisted or braided bundle of the one or more conductor wires and support wire wrapped with tape is at least a substantial fraction of that length.
